(19) United States
(12) Patent Application Publication
(10) Pub. No.: US 2026/0367218 A1
(43) Pub. Date: Nov. 19, 2026

(54) MIMO RADAR SYSTEM HAVING A NEW TYPE OF PHASE MODULATION FOR SUPPRESSING UNDESIRED EFFECTS

(71) Applicant: AUMOVIO Autonomous Mobility Germany GmbH, Ingolstadt (DE)

(72) Inventor: Markus Wintermantel, Lindau (DE)

(73) Assignee: AUMOVIO Autonomous Mobility Germany GmbH, Ingolstadt (DE)

(21) Appl. No.: 19/515,648

(22) PCT Filed: Oct. 23, 2024
(86) PCT No.: PCT/DE2024/200133

§ 371 Date: Mar. 2, 2026

(30) Foreign Application Priority Data
Nov. 8, 2023 (DE) 10 2023 211 066.0

(51) Int. Cl. G01S 7/02; G01S 7/35; G01S 13/58; G01S 13/931

(52) U.S. Cl. CPC G01S 7/0233; G01S 7/354; G01S 7/356; G01S 13/584; G01S 13/931

(57) ABSTRACT

A method for a radar system and a corresponding radar system for sensing the environment, including a transmission device having MTX transmission antennas operating in parallel emitting transmission signals containing one or more sequences of individual signals, a device for changing the phase position of the transmitted individual signals, by which a phase change that is different for the MTX transmission antennas is realized by the individual signals. The phase modulator generates at least three different phase values which are at least approximately equally distributed over the phase unambiguity range 2π, a receiver having one or more receiving antennas for receiving transmission signals reflected by objects, and a signal processor for processing the received signals. The phase modulation is formed by a sum of a linear phase change, possibly apart from phase jumps due to the phase unambiguity range of 2π, and of an irregular phase sequence.

### CROSS-REFERENCE TO RELATED APPLICATIONS

This application is the U.S. National Phase Application of PCT International Application No. PCT/DE2024/200133, filed Oct. 23, 2024, which claims priority to German Patent Application No. 102023211066.0, filed Nov. 8, 2023, the contents of such applications being incorporated by reference herein.

### FIELD OF THE INVENTION

The invention relates to a radar method for a radar system, and to a radar system for use in driver assistance systems in a motor vehicle. The radar system has a respective plurality of transmitting and receiving antennas operated in parallel, which is referred to as MIMO (multiple-input multiple-output), and, according to the invention, uses a novel phase modulation (or the method according to the invention), which avoids undesired effects, in particular ghost detection and falsification of measured values.

### BACKGROUND OF THE INVENTION

Motor vehicles are increasingly being equipped with driver assistance systems which sense the environment with the aid of sensor systems and derive automatic reactions of the vehicle and/or instruct, in particular warn, the driver as a result of the traffic situation recognized therefrom. A distinction is here made between comfort and safety functions.

FSRA (Full Speed Range Adaptive Cruise Control) plays an important role as a comfort function in the current development. In this context, the vehicle adjusts its own speed to the desired speed predefined by the driver, provided that the traffic situation permits it, otherwise the own speed is automatically adapted to the traffic situation.

Safety functions are now available in a variety of forms. In this case, one group is formed by functions for reducing the braking or stopping distance in emergency situations, up to and including autonomous emergency braking. Another group are lane change functions: they warn the driver or intervene in the steering if the driver wants to make a dangerous lane change, i.e. if a vehicle in the adjacent lane is either in the blind spot (known as BSD—“Blind Spot Detection”) or is approaching quickly from behind (LCA—“Lane Change Assist”).

The driver is no longer only assisted, but rather the driver task is increasingly being handled autonomously by the vehicle, i.e., the driver is increasingly being replaced; this is referred to as autonomous driving.

The radar sensors used for systems of the type described above are also often used in combination with sensors based on other technologies, such as camera sensors. One of the advantages of radar sensors is that they operate reliably even in bad weather conditions and can measure not only the distance of objects but also their radial relative speed directly by way of the Doppler effect. Today, 77 GHz and 79 GHz are generally used as transmission frequencies.

The above-mentioned functions require a high detection quality, for which accurate angle formation is absolutely necessary. Therefore, MIMO radars are increasingly being used, which have a plurality of transmitting and receiving antennas operating fully in parallel and which use all combinations of transmitting and receiving antennas for the best possible angle formation. For parallel operation of the transmission antennas, their emitted signals must be modulated differently such that the components they cause in the reception signals can be separated. In this respect, patent EP 2 629 113 B1, incorporated herein by reference, presents the approach whereby a sequence of individual transmission signals is used and the phases of the individual transmission signals are varied; as an example, a binary phase modulation is shown there (i.e. with only two phase values 0° and 180°), which either represents a random sequence or a periodic, in particular alternating course. It is also mentioned that the phase modulation can be composed of a determined and a random component. When random phase modulations are used to distinguish the transmission signals, it is disadvantageous that the integration of reception signals into each transmission antenna over the sequence of individual transmission signals has to be implemented separately, which entails a high level of complexity. This multiple integration circumvents the linear phase modulation known in the prior art, in which the rate of change, that is to say the slope of the linear phase change, is different across the transmission antennas; however, adverse effects of inaccuracies of the phase modulation means and/or of spectral folding can arise in this case.

### SUMMARY OF THE INVENTION

An aspect of the invention aims to provide improved phase modulation for automotive MIMO radar systems, said phase modulation at least largely suppressing the adverse effects occurring in the case of current phase modulations.

The core idea here is that the known linear phase modulation is superimposed with a random phase modulation which is the same for all transmission antennas, wherein said phase modulation uses more than two phase values (i.e., no binary phase modulation), as a result of which numerous positive effects, i.e. elimination of problems that arise otherwise; the integration of reception signals over the sequence of individual transmission signals can be carried out jointly for all transmission antennas, that is to say only once.

The advantages of an aspect of the invention arise from the fact that, by virtue of the novel phase modulation, a high detection quality can be ensured and requirements for hardware, in particular in terms of the quality of the phase modulation means and the required digital processing power can be reduced.

The radar system to which the method for sensing the environment according to an aspect of the invention relates contains 1) transmission means with M_{TX} transmission antennas operating in parallel for emitting transmission signals which contain one or more sequences of K individual signals, the general form of which is preferably identical or similar, 2) means for changing the phase position of the transmitted individual signals, by means of which a phase change that is different for the M_{TX} transmission antennas is realized by the K individual signals, referred to hereinafter as phase modulation, wherein said phase modulation means can generate at least three different phase values, which are preferably at least approximately equally distributed over the phase unambiguity range 2π, 3) receiving means having one or more receiving antennas for receiving transmission signals reflected by objects, and 4) signal processing means for processing the received signals. The method is characterized in that the phase modulation is formed by the sum of a linear phase change, possibly apart from phase jumps due to the phase unambiguity range of 2π, and of an irregular phase sequence, wherein the linear phase change has a different slope across the transmission signals of the M_{TX} different transmission antennas and is used to separate the components caused by the transmission signals of the different transmission antennas in the received signals, while the superposed irregular component across the M_{TX} different transmission antennas is identical and is used in particular to reduce or prevent effects of inaccuracies of the phase modulation means and/or effects of spectral convolutions.

The superposed irregular phase sequence can expediently assume random or pseudorandom values.

Furthermore, in the digital signal processing means, there can be integration via K signals which are derived from the reception signals to the K transmission signals, this integration being carried out only once for the signals to the M_{TX} different transmission antennas and compensation of the irregular phase component taking place beforehand.

An advantageous embodiment of the invention is characterized in that the integration via K signals, which are derived from the reception signals to the K transmission signals, is carried out as a discrete Fourier transformation, preferably in the form of a fast Fourier transformation, and the components corresponding to the different transmission antennas lead to power peaks at different points in the resulting spectrum.

Expediently, the individual transmission signals can be linearly modulated in terms of frequency, wherein their center frequency may change successively, or represent OFDM signals or be generated using pseudorandom fast phase modulation.

Further, the irregular component of the phase modulation can also be used to decorrelate effects from radiation via receiving antennas caused by limited isolation, effects of internal couplings and interference from other radar systems, and hence to mitigate or prevent negative effects from said effects.

### BRIEF DESCRIPTION OF THE DRAWINGS

FIG. 1 shows the exemplary embodiment of a radar system.

FIG. 2 illustrates the frequency modulation consisting of a sequence of frequency ramps.

FIG. 3A shows the magnitude of the two-dimensional spectrum in the object distance gate j₀, that is to say |Ŝ₂(j₀, l, m_{TX}, m_{RX})|, without a random phase modulation component, FIG. 3B with a random phase modulation component; in this case, inaccuracies occurring in real phase shifters are assumed, that is to say small phase errors and amplitude errors.

### DETAILED DESCRIPTION OF AN EXEMPLARY EMBODIMENT

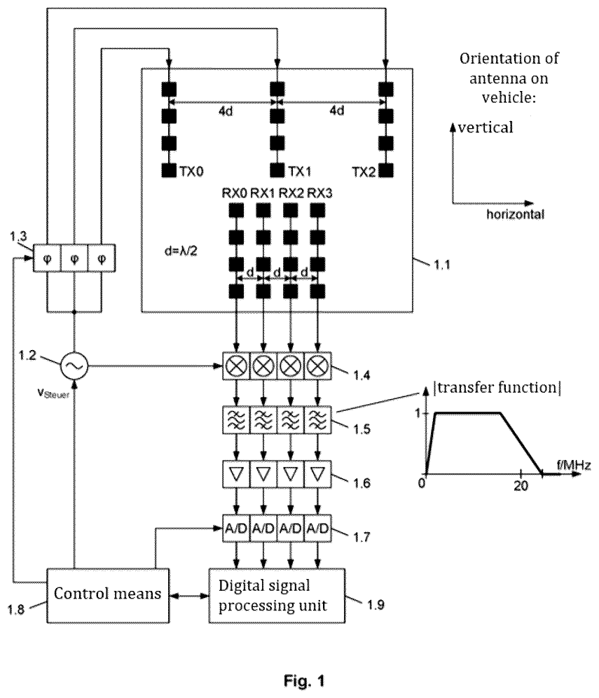

Consideration is given to the exemplary embodiment of a radar system, which is roughly illustrated in FIG. 1. The radar system has M_{TX}=3 transmission antennas TX0-2 for emitting transmission signals and M_{RX}=4 receiving antennas RX0-RX3 for receiving transmission signals reflected at objects; the antennas are embodied on a planar circuit board 1.1 using planar technology as patch antennas, wherein this board is oriented with respect to the horizontal and vertical directions in the vehicle as illustrated in the image and looks in the direction of travel. All antennas (transmitting and receiving antennas) have the same beam characteristic in elevation and in azimuth. The M_{RX}=4 receiving antennas (and hence their phase, i.e. emission centers) are each at the same lateral, i.e. horizontal, distance d=λ/2=1.96 mm from one another, where λ=c/76.5 GHZ=3.92 mm is the mean wavelength of the emitted signals in the frequency band 76-77 GHz used and c=3*10⁸ m/s is the speed of light. The M_{TX}=3 transmission antennas are at four times the horizontal distance thereto, i.e., 4d=2λ, such that all combinations of transmitting and receiving antennas synthetize an equidistant array of M_{TX}−M_{RX}=12 antenna channels in the grid d=λ/2, which is used to determine the azimuth angle of objects.

The transmission signals emitted on the transmission antennas are obtained from the high-frequency oscillator 1.2 in the 76-77 GHz range, the frequency of which can be changed by means of a control voltage v_{Control}. The control voltage is generated in the control means 1.8, wherein these control means contain e.g. a phase control loop or a digital-analog converter, which are controlled such that the frequency profile of the oscillator corresponds to the desired frequency modulation. The phase position of the transmission signals can be set and varied individually for the M_{TX} transmission antennas by means of phase shifters 1.3; the phase shifters 64 realize at least approximately uniformly distributed phase values over the phase unambiguity range 2π. These phase shifters modulate transmission signals from the different transmission antennas differently, with the result that parallel transmission on all transmission antennas, that is to say MIMO operation, is possible, because the components originating from the different transmission antennas can be separated after demodulation in the reception signals.

The signals received by the four receiving antennas are down-mixed in parallel with the signal of the oscillator 1.2 into the low-frequency range in the real value mixers 1.4. The reception signals then pass through the bandpass filters 1.5 having the transfer function illustrated, the amplifiers 1.6 and the analog-to-digital converters 1.7. They are then processed further in the digital signal processing unit 1.9.

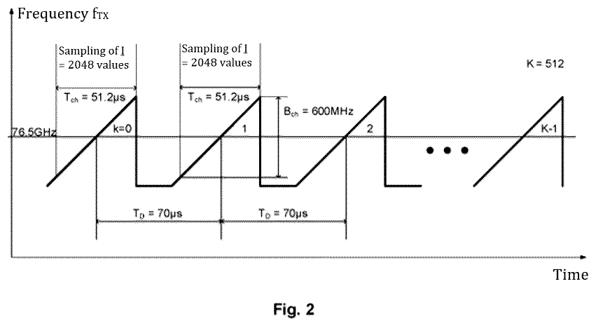

In order to be able to measure the distance to objects, the frequency f_{TX} of the high-frequency oscillator and hence of the transmission signals is linearly changed very quickly (in T_{ch}=51.2 μs around B_{ch}=600 MHz, as shown in FIG. 2, the center frequency being f_{c}=76.5 GHz); this is referred to as a frequency ramp (often also referred to as “chirp”). The frequency ramps are periodically repeated in a fixed grid T_{D}=70 μs; in total, there are K=512 frequency ramps, which all have the same frequency response, i.e. the same frequency slope, the same frequency position (that is to say in particular the same starting and middle frequencies) and the same duration. In recent years, this type of modulation has become increasingly widespread and adopted in radars for sensing the environment of motor vehicles. It allows a high sensor range and speed resolution (through long data acquisition time) as well as a high distance resolution (through the use of high modulation bandwidth).

During each frequency ramp k=0, . . . , K−1, the reception signals from each of the M_{RX} A/D converters are sampled l=2048 times at intervals of Tₛ=25 ns (i.e. at 40 MHz), wherein the sampling always begins at the same time relative to the start of the ramp (see FIG. 2); the resulting digital samples with an index i=0, . . . , l−1 in the reception path m_{RX} are denoted by s(i, k, m_{RX}). Signal sampling only makes sense in the time range in which reception signals from objects arrive in the range of interest—after the ramp start, it is therefore necessary to wait for at least the transit time corresponding to the distance of maximum interest (for a distance of maximum interest of 200 m, this corresponds to 1.33 μs); it is to be noted that here and below “distance” is always to be understood to mean the radial distance, and “relative speed” is understood to mean its radial component.

As is known from the prior art (see e.g. EP 2 629 113 B1) and can also be easily derived, the sampling signal s(i, k, m_{TX}, m_{RX}) effected by the transmission signal of a transmission antenna m_{TX} represents, in the case of a single point-like object at a distance r, a sinusoidal oscillation across the index i, which can be described in very good approximation as follows:

\hat{s}(i, k, m_{TX}, m_{RX})=A·sin[2π·i/l·j₀+φᵥ(k)+φ_{PM,TX}(k,m_{TX})+φ_{α,TX}(m_{TX})+φ_{α,RX}(m_{RX})] (1)

where j₀=r/(meter)·B_{ch}/150 MHz, (2)

that is to say that the frequency of the oscillation is proportional to the object distance r (j₀ is a standardized frequency). A radial relative movement of the object with respect to the sensor gives rise to a phase position contribution φᵥ(k) of the sinusoidal oscillation that changes over the K=512 frequency ramps; in the case of a movement with a constant radial velocity component v, the result is:

φᵥ(k)=2π·k/K·l₀ with l₀=2KT_{D}vf_{c}/c, (3)

that is to say a linear change in phase position across the frequency ramps k, wherein the rate of change of the phase is proportional to the radial relative speed v of the object. The phase contribution φ_{PM,TX}(k,m_{TX}) in above relation (1) describes the phase modulation implemented with the phase shifters 1.3

φ_{PM,TX}(k,m_{TX})=φ_{PM,lin}(k,m_{TX})+φ_{PM,r}(k), (4a)

which has two components: On the one hand, the component that changes linearly across the frequency ramps k

φ_{PM,lin}(k,m_{TX})=2π·k·p(m_{TX})/P (4b)

with normalized rates of change p(m,_{TX})/P which differ across the transmission paths with an integer common period P and normalized rates of change p(m_{TX}), considered here to be integer, (normalized with respect to the slowest rate of change 1/P); this component is used to later separate the components in the reception signals coming from the different transmission paths (see also the explanations below). On the other hand, a random or pseudorandom component φ_{PM,r}(k) across the frequency ramps k, which component is identical for all of the transmission paths and which is generated by a random selection for each frequency ramp k from the 64 phase values of the phase shifters 1.3; this component according to an aspect of the invention serves for suppressing undesired effects, which will be deduced and explained later. The two rear phase components φ_{α,TX}(m_{TX}) and φ_{α,RX}(m_{RX}), which are independent of the frequency ramps k, represent the phase positions for the different transmission and reception paths, which are dependent on the azimuth angle a of the object. It should also be noted that actually realized phase values are in the range of 0 . . . 2π, since, on account of the cyclic property of phases, all phase values can be mapped to this range, which is a modulo functionality from a mathematical point of view.

Finally, with regard to relation (1), it should also be mentioned that the amplitude A of the reception signal is assumed to be independent of the transmission and reception path, that is to say all transmission and reception paths are intended to have the same strength in each case; this assumption has no influence on further considerations.

In the digital signal processing unit 1.9, a first discrete Fourier transformation (DFT=Discrete Fourier Transform) is carried out for the reception signals s(i, k, m_{RX}) per frequency ramp k and reception path m_{RX} after multiplication by a suitable window function w₁(i) using the time index i=0, . . . , l−1, since this corresponds to optimal filtering for the signal form (1); the DFT is expediently implemented using fast Fourier transformation (FFT=Fast Fourier Transform). With the dependence

sin(x)=(exp(ĵ·x)−exp(−ĵ·x))/(2ĵ), (5)

wherein “exp” denotes the exponential function and ĵ is the imaginary unit, the DFT, that is to say the spectrum_{ŝ1}(j, k, m_{TX}, m_{RX}) of the sampling signal ŝ(i, k, m_{TX}, m_{RX}) caused by a transmission path, is given by:

Ŝ₁(j,k,m_{TX},m_{RX})=A/(2ĵ)·[exp(\hat{j}(φᵥ(k)+φ_{PM,TX}(k,m_{TX})+φ_{α,TX}(m_{TX})+φ_{α,RX}(m_{RX})))·W₁(modⱼ(j−j₀))−exp(−ĵ)(φᵥ(k)+φ_{PM,TX}(k,m_{TX})+φ_{α,TX}(m_{TX})y+φ_{α,RX}(m_{RX})))·W₁(modⱼ(j+j₀))], (6)

where j=0, . . . , l−1 is the running variable for the image region, i.e., the frequency range of the DFT, and represents the so-called distance gates (because the frequency of the received signal is proportional to the distance), W₁(j) is the spectrum of the window function w₁(i) used, and “modⱼ” represents the modulo function for the module J. The spectrumw₁(j) of the window function has a rather sharp power peak at j=0, which extends approximately over three frequency values j. According to rel. (6), the spectrum Ŝ₁(j, k, m;_{TX}, m_{RX}) effected by a single object thus has two power peaks at the frequencies j,₀ and l−j₀ (assuming 0≤j₀≤1, which is valid owing to non-negative distances and the action of the bandpass filters 1.5). If 0≤j₀≤l/2, then the power peak at l−j₀, i.e. in the upper half of the spectrum, carries no additional information, which applies very generally to the upper half of the spectrum, because this is conjugated complex reflected to the lower half on the basis of the real-valued input signal; therefore, for further processing only the lower half of the spectrum is considered, i.e., only the frequencies or distance gates j=0 . . . l/2.

Before a second DFT can be performed over the dimension k, the random phase component φ_{PM,r}(k) of the phase modulation φ_{PM,TX}(k,m_{TX}) according to rel. (4a) has to be compensated (the remaining phase components represent a linear phase profile over dimension k, which is necessary for the application of the DFT as optimal filtering). For the distance gate region of interest, j₀=0 . . . l/2 (i.e., objects that are located there), the first term in rel. (6) is relevant (after all, only the lower half of the spectrum j=0 . . . l/2 is considered), such that, in order to compensate for the random phase modulation component, it is necessary to multiply by exp(−ĵ·φ_{PM,r}(k)); this then gives:

Ŝ_{1,komp}(j,k,m_{TX},m_{RX})=A/(2ĵ)·[exp(ĵ(φᵥ(k)+φ_{PM,lin}(k,m_{TX})+φ_{α,TX}(m_{TX})+φ_{α,RX}(m_{RX})))·W₁(modⱼ(j−j₀))−exp(−ĵ(φᵥ(k)+φ_{PM,lin}(k,m_{TX})+2φ_{PM,r}(k)+φ_{α,TX}(m_{TX})+φ_{α,RX}(m_{RX})))·W₁(modⱼ(j+j₀))]. (7)

For each distance gate j and reception path m_{RX} and after multiplication by a window function w₂(k), a second DFT is then carried out, this time over the frequency ramp index k (preferably again using an FFT); this results in the two-dimensional spectrum

Ŝ₂(j,l,m_{TX},m_{RX})=A/(2ĵ)·[exp(ĵ(φ_{α,TX}(m_{TX})+φ_{α,RX}(m_{RX})))·W₁₂(modⱼ(j−j₀), mod_{K}(l−l₀₋ₚ(m_{TX})·K/P))−R_{PM}(l+l₀+p(m_{TX})·K/P)·exp(−ĵ(φ_{α,TX}(m_{TX})+φ_{α,RX}(m_{RX})))·W₁(modⱼ(j+j₀))], (8)

wherein l=0, . . . , K−1 is the running variable for the image region, i.e. the frequency range of the second DFT, and represents the so-called Doppler gates (because frequency is proportional to relative speed, apart from the additional phase modulation component p(m_{TX})·K/P), W₁₂(j,l) is the two-dimensional spectrum of the two-dimensional window function w₁(i)·w₂(k) used (has power peak at j=0 and l=0) and R,_{PM}(l) represents the spectrum of the unit vector exp(−ĵ2φ_{PM, r}(k)), which has a random phase profile, (2φ,_{PM, r}(k) randomly assumes values from 32 different phase values evenly distributed over 2π—the modulo property of the phase is already taken into account); thus, R_{PM}(l) itself is also noise which is Rayleigh-distributed. For an object in the distance gate region of interest j₀=0 . . . l/2, the two-dimensional spectrum Ŝ₂(j, l, m,_{TX}, m_{RX}) according to rel. (8) of the first term yields a power peak at the distance gate j=j₀ and Doppler gate l=l₀+p(m_{TX})·K/P; the second term generates noise at j=l−j₀ (and its immediate proximity) which is distributed over all of the Doppler gates k, wherein this j is outside the distance gate region of interest and consideration, j=0 . . . l/2.

Now an object is considered above the distance gate region of interest, i.e. in the range j₀=(l/2+1) . . . (l−1); because of the transition region of the bandpass filters 1.5, which has only a comparatively low attenuation, objects can be received, in particular, little above j₀=l/2—this is referred to as overrange. Then, in the two-dimensional spectrum Ŝ₂(j, l, m_{TX}, m_{RX}) according to rel. (8) of the first term, a power peak arises at a j=j₀ above the considered distance gate range j=0 . . . l/2, while the second term at the distance gate j=l−j₀ in the distance gate region of interest and under consideration j=0 . . . l/2 generates noise distributed over all of the Doppler gates k. However, this noise will not result in detection even if it is significantly higher than the system noise, since detections are made only for power peaks in the dimension k which are significantly above the total noise level there. If the random phase modulation component P_{PM,r}(k) did not exist, the two-dimensional spectrum Ŝ₂(j, l, m_{TX}, m_{RX}) would be as follows (can be seen from rel. (7) and (8)):

Ŝ₂(j,l,m_{TX},m_{RX})=A/(2ĵ)·[exp(ĵ(φ_{α,TX}(m_{TX})+φ_{α,RX}(m_{RX})))·W₁₂(modⱼ(j−j₀),mod_{K}(l−l₀−p(m_{TX})·K/P))−exp(−ĵ(φ_{α,TX}(m_{TX})+φ_{α,RX}(m_{RX})))·W₁₂(modⱼ(j+j₀),mod_{K}(l+l₀+p(m_{RX})·K/P))]. (9)

This would mean that an overrange, i.e., an object in the range j₀=(l/2+1) . . . (l−1) would lead now by the second term to a power peak at the distance gate j=l−j₀ in the distance gate region of interest and under consideration j=0 . . . l/2; it would thus erroneously be formed a detection which not only has an incorrect (too small) distance, but also whose measured values for relative speed and angle are incorrect (because of incorrect signs of the contributing variables in the second term of rel. (9)).

The random phase modulation component φ_{PM,r}(k) thus prevents incorrect detections due to overrange; the noise produced instead is, in terms of its average power, approximately 26 dB below the power peak that would arise without a random component (the 26 dB results from the DFT integration gain of 10·log₁₀(K=512)=27 dB minus approximately 1 dB window loss). It should also be mentioned that the above considerations do not apply to a binary phase shifter, that is to say only having the two states 0 and π; because then the phase component 2φ_{PM,r}(k) in the second term of rel. (7) is always 0 (phase 2π corresponds to phase 0) and thus has no effect, so that the second term of the two-dimensional spectrum Ŝ2(j, l, m_{TX}, m_{RX}) does not represent noise, but rather, according to rel. (9), also generates a power peak, which then leads to the undesired overrange effect. Therefore, at least three different phase values are needed to convert overrange to noise.

Problems caused by overrange arise from a convolutional effect, i.e., the mapping of frequencies to other frequencies; if frequencies at other frequencies still have certain power components, then this is referred to as overconvolution—overall, such effects are also referred to as spectral convolutional effects. Such an overconvolutional effect exists with very close objects; consider as an example an object at distance gate j₀=0.5 (it should be noted that signals from such nearby objects can be received despite the high attenuation of the bandpasses 1.5 for this purpose, since they generate a very strong signal at the receiving antenna due to the short distance). Without the random phase modulation component φ_{PM,r}(k), in the two-dimensional spectrum Ŝ2(j, l, m_{TX}, m_{RX}) according to rel. (9), parts of both terms would then be effective at the distance gate j=0 (the power peak with the shape of the two-dimensional window spectrum W₁₂ has a certain width and typically extends over 3 distance gates); the first term gives the correct information, while the second term is erroneous information. These erroneously occurring components of the second term can either lead to falsification of the measured values of the object (if they overlap with the real parts of the first term and then, for example, influence the distance interpolation) or to non-real detections, i.e. ghost detections (if they do not overlap with the real parts of the first term and thus form independent power peaks). Due to the random phase modulation component φ_{PM,r}(k), the second term of the two-dimensional spectrum_{Ŝ2}(j, l, m_{TX}, m_{RX}) according to rel. (8) represents noise, so that there are no ghost detections; and since the noise is far below the real power peaks from the first term, the effect on the measured values of the object (distance, relative speed and angle) is also negligibly small.

Adverse effects of spectral convolutions are thus avoided by the random phase modulation component φ_{PM,r}(k).

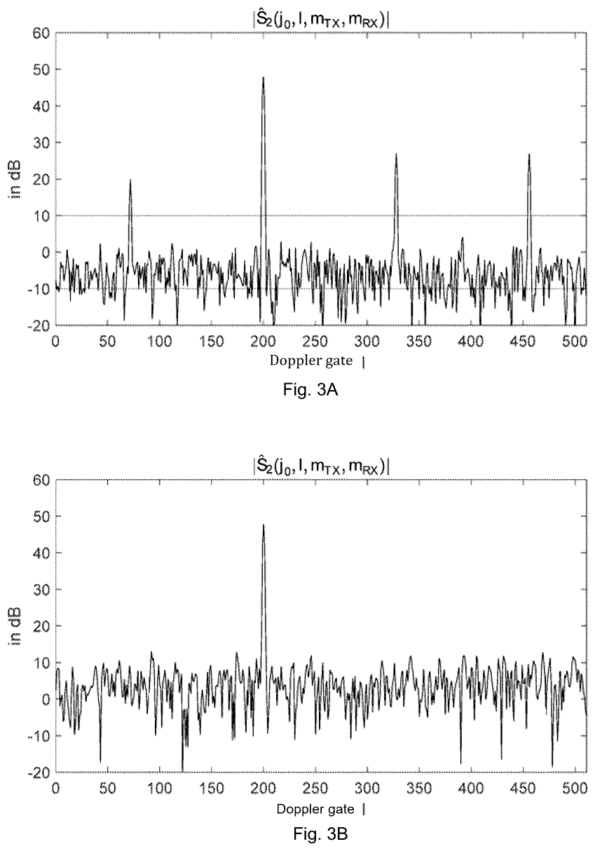

A fundamental problem with phase modulation is that the means used to achieve it, in particular phase shifters, are never ideal and therefore always exhibit certain errors. The 64 phase values of the phase shifters under consideration here, which are ideally distributed uniformly over the phase range 2π=360°, are intended to have a standard deviation of 5°; and in addition, the amplitude of the realized vectors is also supposed to have a standard deviation of 10%. The modulation period used should be P=4, and for the transmission path m_{TX} under consideration, the modulation change rate should be p(m_{TX})=1. In the absence of a random modulation component, the four setpoint phase values 0, 90°, 180° and 270°, which are generated using the phase shift indices 0, 16, 32 and 48, are then to be periodically repeated according to rel. (4b); these should have the real phase values −5°, 91°, 185° and 263° and the amplitude values 1.02, 1.1, 0.85 and 1.11. For an object at a distance gate j₀<l/2 and at the Doppler gate l₀=72, the resulting two-dimensional spectrum in the object distance gate j₀, i.e. Ŝ₂(j₀, l, m_{TX}, m_{RX}), is then illustrated in FIG. 3A in terms of magnitude and in dB; in addition to the regular power peak at l=l₀+K/P=200, further power peaks also occur in the grid K/P=128 (harmonic frequencies of period P=4), which are generated by the non-ideal phase shift values and their periodic repetition and can lead to incorrect detection, that is to say ghost detection. If the harmonics fall on the correct power peaks of other transmission antennas, they can falsify the angle formation result. It should also be mentioned that in FIG. 3A the noise significantly below the power peaks comes from system noise, which is not represented in the formulas above.

When using the randomly superposed phase component φ_{PM,r}(k) of the phase modulation φ_{PM,TX}(k, m_{TX}) according to rel. (4a) as described in an aspect of the invention, four phase values are no longer periodically repeated, but rather quasi-random phase values are used (the linear phase component is no longer visible); hence, the phase modulation errors (phase and amplitude) are also no longer periodic but quasi-random, with the result that power peaks of harmonics no longer occur in the spectrum Ŝ₂(j₀, l, m_{TX}, m_{RX}) according to FIG. 3B—the energy of which is distributed in noise. The superposed random phase modulation component φ_{PM,r}(k) thus avoids ghost detections as a result of the inaccuracies in the phase modulation means which always occur and thus also permits the use of rather poor phase shifters, which can lead to a cost reduction.

In addition to the advantages presented previously by way of the random phase modulation component φ_{PM,r}(k), this also has the effect that radiations via the receiving antennas (due to their limited TX isolation), internal couplings between the transmission and reception paths, and interference from other radar systems are decorrelated and thus converted to noise—they therefore cannot significantly impair the measured value quality of objects and cannot generate ghost detection.

Previously, only the contribution from one transmission path m_{TX} was considered in each case. The two-dimensional total spectrumS₂(j, l, m_{RX}) generated by all of the M_{TX}=3 transmission paths is the sum of the individual contributions represented in the above formulas (that is to say the sum over m_{TX}=0, . . . , M_{TX-1}). Since the random phase modulation component φ_{PM,r}(k) is constant over all M_{TX}=3 transmission paths, its compensation and the second DFT need to be calculated only once for all transmission paths, that is to say not for each separately (the latter would be necessary if the random phase modulation component were different between the transmission paths, which would result in significantly increased computation complexity). The modulation for distinguishing the transmission paths, that is to say the linear phase change φ_{PM,lin}(k, m_{TX}) which differs between the transmission paths, also does not require multiple second DFT, since it does not need to be compensated for before the DFT because, without compensation in the DFT, it simply results in a corresponding shift in the power peaks. After this second DFT, which is carried out jointly for all transmission paths (that is to say only once), M_{TX} power peaks then arise at the positions corresponding to the transmission paths (that is to say the linear phase change thereof); this allows the separation of the components caused by the different transmission paths, which is necessary for MIMO operation (i.e., using all combinations of transmitting and receiving antennas for the angle formation with parallel operation of the transmission antennas). The advantages and effects of the random phase modulation component φ_{PM,r}(k) presented above are naturally also retained in the total spectrum of all M_{TX}=3 transmission paths (they apply to each individual transmission path and hence also to the sum thereof).

Until now, only a single point-like object has been considered. The above considerations remain valid even in the case of multiple and/or extended objects (since this means only a linear superposition of a plurality of individual signals).

The radar system under consideration so far has multiple receiving antennas and thus multiple reception paths; of course, just one receiving antenna would also be possible, but this is generally not very favorable (poor angle formation and unfavorable, i.e., poorly balanced, utilization of the hardware resources used, since transmission paths are complex to implement).

Up to now, a real value mixer has been considered. In the ideal case, a complex-valued mixer (also known as an IQ mixer) has only one power peak; in the real case, however, the IQ generation is not quite perfect, so that there is also a smaller power peak at a negative frequency, which can lead to ghost detection or falsification of measured values. This power peak is also converted to noise by the random phase modulation component φ_{PM,r}(k), and therefore negative effects resulting therefrom are avoided.

In the case of the modulation according to FIG. 2 considered above, all the frequency ramps have the same frequency range, that is to say the starting frequency (and thus center frequency). For improved distance resolution, as described in DE 10 2020 210 079 B3, incorporated herein by reference, the start frequency can be changed linearly over the frequency ramps, wherein the distance between the frequency ramps preferably also changes linearly in this case. This has no effect on the phase modulation according to an aspect of the invention and its advantages, i.e., they remain unchanged.

Until now, the transmission signal that is repeated sequentially has been considered to be a linear frequency ramp. Instead of a frequency ramp, however, other signal forms can also be used, for example a signal with pseudorandom binary phase modulation (i.e., the sign is changed very quickly pseudorandomly within the signal) or an OFDM signal (OFDM=Orthogonal Frequency Division Multiplexing). The sample values (after analog-to-digital conversion) cannot then be used directly as input values for the above first DFT, but firstly the Fourier transformed has to be calculated for each transmission signal and receiving antenna and divided by the spectrum of the transmission signal.

Finally, it should be noted that it is obvious to a person skilled in the art how the considerations and explanations of an aspect of the invention described in the above application example can be transferred to general calculations and parameter designs, i.e., they can also be applied to other numerical values.

1. A method for a radar system for sensing the environment, comprising
transmission means having MTX transmission antennas operating in parallel for emitting transmission signals containing one or more sequences of K individual signals, the general form of which is preferably identical or similar,
means for changing the phase position of the transmitted individual signals, by means of which a phase change that differs for the MTX transmission antennas is realized by means of the K individual signals, referred to hereinafter as phase modulation, wherein said phase modulation means can generate at least three different phase values which are preferably at least approximately equally distributed over the phase unambiguity range 2π,
receiving means having one or more receiving antennas for receiving transmission signals reflected by objects,
and signal processing means for processing the received signals,
wherein the phase modulation is formed by a sum of a linear phase change, possibly apart from phase jumps due to the phase unambiguity range of 2π and of an irregular phase sequence, wherein the linear phase change has a different slope across the transmission signals of the M_{TX} different transmission antennas and is used to separate the components in the received signals caused by the transmission signals of the different transmission antennas, while the superposed irregular component is identical across the M_{TX} different transmission antennas and is used in particular to reduce or prevent effects of inaccuracies of the phase modulation means and/or effects of spectral convolutions.

2. The method according to claim 1, in which the superposed irregular phase sequence assumes random or pseudorandom values.

3. The method according claim 1, in which, in the digital signal processing means, an integration over K signals which are derived from the reception signals, to the K transmission signals, is performed, wherein said integration is carried out only once for the signals to the M_{TX} different transmission antennas and compensation of the irregular phase component takes place beforehand.

4. The method according to claim 3, in which the integration over K signals, which are derived from the reception signals, to the K transmission signals, is carried out as a discrete Fourier transformation, preferably in the form of a fast Fourier transformation, and the components corresponding to the different transmission antennas lead to power peaks at different points in the resulting spectrum.

5. The method according to claim 1, in which the individual transmission signals are linearly modulated in terms of frequency, wherein their center frequency may change successively, or represent OFDM signals or are generated using pseudorandom fast phase modulation.

6. The method according claim 1, in which the irregular component of the phase modulation can also be used to decorrelate effects from radiation via receiving antennas caused by limited isolation, effects of internal couplings and interference from other radar systems, and hence to thereby mitigate or prevent negative effects from said effects.

7. A radar system for sensing the environment, comprising
transmission means with MTX transmission antennas operating in parallel for the emission of transmission signals containing one or more sequences of K individual signals, the general form of which is preferably identical or similar,
means for changing the phase position of the transmitted individual signals, by means of which a phase change that differs for the MTX transmission antennas is realized over the K individual signals, referred to hereinafter as phase modulation, wherein said phase modulation means can generate at least three different phase values which are preferably at least approximately equally distributed over the phase unambiguity range 2π,
receiving means having one or more receiving antennas for receiving transmission signals reflected by objects,
and signal processing means for processing the received signals,
wherein the phase modulation is formed by a sum of a linear phase change, possibly apart from phase jumps due to the phase unambiguity range of 2π and of an irregular phase sequence, wherein the linear phase change has a different slope across the transmission signals of the M_{TX} different transmission antennas and is used to separate the components in the received signals caused by the transmission signals of the different transmission antennas, while the superposed irregular component is identical across the M_{TX} different transmission antennas and is used in particular to reduce or prevent effects of inaccuracies of the phase modulation means and/or effects of spectral convolutions.
